(19) United States
(12) Patent Application Publication
(10) Pub. No.: US 2011/0016742 A1
(43) Pub. Date: Jan. 27, 2011

(54) SPRAY FREEZE DRYING

(75) Inventors: Steve Anderson, Blenheim (NZ); James Kenneth Carson, Hamilton (NZ); John Cuddon, Blenheim (NZ); Steven Planthaber, Blenheim (NZ)

Correspondence Address: KNOBBE MARTENS OLSON & BEAR LLP, 2040 MAIN STREET, FOURTEENTH FLOOR, IRVINE, CA, 92614, US

(73) Assignee: AGRESEARCH LIMITED, Hamilton (NZ)

(21) Appl. No.: 12/445,797

(22) PCT Filed: Oct. 16, 2007
(86) PCT No.: PCT/NZ07/00305

§ 371 Date: Oct. 13, 2010

(30) Foreign Application Priority Data
Oct. 16, 2006 (NZ) 550563

(51) Int. Cl. F26B 5/06

(52) U.S. Cl. 34/287; 34/92

(57) ABSTRACT

The invention relates to a spray freeze dryer apparatus and method of using same for use in drying or concentrating a raw material which at ambient conditions has a solid and an aqueous portion. The dryer includes a chamber and a chamber pressure reduction device; an inlet nozzle or nozzles through which the raw material is injected into the chamber; and a collection surface or surfaces which collect a frozen portion of the raw material. The chamber is kept at a pressure below the triple-point pressure of the aqueous portion of the raw material. Several additional features are described to control the thickness of the layer on the collection surface.

### STATEMENT OF CORRESPONDING APPLICATIONS

This application is based on the Provisional specification filed in relation to New Zealand Patent Application Number 550563, the entire contents of which are incorporated herein by reference.

### TECHNICAL FIELD

The invention relates to improvements in spray freeze drying.

### BACKGROUND ART

Spray freeze drying is discussed in the applicant's co-pending patent, NZ 529594/529595 (also published as WO 2005/105253) incorporated herein by reference. As mentioned in these specifications, freeze drying materials is well known in the art, for example to remove an aqueous component from a solid suspension leaving a dry solid which may have various uses such as for forming tablets and capsules.

In the applicants co-pending patent, methods and apparatus are described to produce a dried solid from a freeze dryer whereby the solid may be produced on a continuous basis. A key improvement in the previous apparatus and methods was to spray the inlet material and subsequent collection on a conveyed collection surface.

Further improvements on the methods and apparatus disclosed in the co-pending patent applications are now disclosed.

It is an object of the present invention to at least to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

Further aspects and advantages of the present invention will become apparent from the ensuing description which is given by way of example only.

### DISCLOSURE OF INVENTION

According to a first aspect of the present invention there is provided an apparatus for drying or concentrating a raw material which at ambient conditions has a solid and aqueous portion including:
(a) a chamber and a chamber pressure reduction device; and,
(b) at least one inlet nozzle through which the raw material is injected into the chamber;
(c) at least one collection surface which collects a frozen portion of the raw material; and,
wherein the pressure reduction device maintains the chamber at a pressure below at least the triple-point pressure of the aqueous portion of the raw material, to cause the injected raw material to separate into a frozen portion and a first evaporated portion; and,
characterised in that the frozen portion is collected on at least one collection surface and accumulated as a layer on the surface or surfaces, the thickness of which is controlled by at least one parameter selected from:
i. the raw material inlet flow rate;
ii. use of positive inlet pressure;
iii. inlet nozzle size and configuration; and/or,
iv. the distance between the inlet nozzle outlet and the collection surface.

According to a further aspect of the present invention there is provided a method of drying or concentrating a raw material which at ambient conditions has a solid and an aqueous portion by the steps of:
(a) holding a chamber at a temperature and pressure below the triple-point of the aqueous portion of the raw material;
(b) injecting the raw material into the chamber from at least one inlet nozzle to generate a frozen portion and a first evaporated portion;
(c) collecting the frozen portion as a layer on at least one collection surface;
(d) conveying the collected frozen portion on the collection surface or surfaces; and,
characterised in that the thickness of the frozen portion on the collection surface is controlled by at least one parameter selected from:
i. the raw material inlet flow rate;
ii. use of positive inlet pressure;
iii. inlet nozzle size and configuration; and/or,
iv. the distance between the inlet nozzle outlet and the collection surface.

Preferably, the thickness of the layer collected on the collection surface is also controlled by the rate of conveyance of the collection surface.

The inventors have found that several critical features are involved in forming a frozen layer on the collection surface beyond just the rate of conveyance. Forming a layer that is smooth, continuous and fine (termed for the purposes of this specification as a ‘monolayer’) is critical in achieving a uniformly dried product from the dryer. Preferably, the frozen layer on the collection surface is characterised by being smooth, continuous and a fine width. For the purposes of this specification, the term ‘fine width’ refers to the layer being less than 10 mm in width. In preferred embodiments, the width is less than 5 mm.

For the purposes of this disclosure and ease of reading, the collection surface may be referred to interchangeably as a conveyer belt. This should not be seen as limiting as other conveying methods such as those described in NZ 529594/529595 are also envisaged.

Preferably, the raw material is a solid suspended in or dissolved in the aqueous portion. More preferably, the raw material includes up to 50% solid material. Still more preferably, the raw material includes less than 30% solid material. As should be appreciated by those skilled in the art, these parameters equate to various dairy products such as milk to be dried, nutraceutical extracts and other products. It is envisaged that the raw material could also be a frozen solid material containing an aqueous portion. For example, the dryer assembly may be used for continuous drying of solid materials such as frozen vegetables. Further reference will be made to drying of solid/aqueous mixtures however this should not be seen as limiting.

Preferably, the raw material inlet flow rate is tailored to the collection surface size at a ratio of 1 kg/hour of raw material per 0.25 to 1.5 metres of collection surface width. As noted above, a key parameter found to achieve formation of a monolayer on the collection surface is use of an inlet rate tailored to the conveyer belt width. In one embodiment, the inlet rate is approximately 10 kg/hour of raw material to be dried on an approximately 0.5 m wide and 9 metre long conveyer belt. If the rate is increased above this level, product collected on the belt may be too thick to dry sufficiently and may also not fully freeze on formation of a monolayer resulting in small explosions as described further below.

A further key parameter found by the inventors is that the raw material is pumped into the vacuum chamber using a positive pressure rather than relying on the vacuum in the chamber alone to drive the dispersion of raw material into the chamber. In preferred embodiments, the back pressure ranges from approximately 20 to 40 psi. One problem noted by having insufficient back pressure is that discrete snow-like crystals are deposited on the conveyer belt surface rather than formation of a monolayer. The crystals also tend to blow around the chamber, not staying in one position (a monolayer) during drying.

The inventors have found that, once vacuum pressure and inlet pressure are stabilised, the inlet nozzle applies the raw material as a flat sheet monolayer on a continuous basis for hours at a time without need to adjust any parameters.

In preferred embodiments as described in NZ 529594/529595, the raw material is dispersed into the vacuum chamber using a nozzle or nozzles that atomise the raw material into small particles.

A further key parameter in achieving the desired size of particle as well as achieving a monolayer of material on the conveyer belt is nozzle selection. Preferably, the inlet nozzle or nozzles are selected based on injecting sufficient quantities of raw material such that:
(i) initial sublimation of first evaporated portion can occur;
(ii) the frozen portion transfers to a solid; and
(iii) the nozzle size is tailored to the raw material viscosity.

It is the inventors' experience that atomiser nozzle choice is a critical variable. Preferred nozzle types are those that are relatively small and spray a half cone shaped arrangement. Full cone nozzle types may be used but the inlet flow of raw material must then be carefully regulated to ensure that liquid material does not become frozen under a solid cap on the conveyer belt resulting in sublimation and small explosions (see below). Nozzles are preferably sized to account for material viscosity. For example, materials with higher viscosity require larger nozzle sizes in order to ensure a smooth flow and full atomisation of the raw material.

A yet further key parameter in the inventors experience is the distance between the inlet nozzle and the collection surface. In preferred embodiments, the distance between the inlet nozzle or nozzles and the collection surface or surfaces varies from between 70 and 120 mm. In a particularly preferred embodiment, this distance is approximately 90 mm, although, it should be appreciated that this may vary depending on at least the raw material and nozzle configuration.

Preferably, the inlet nozzle or nozzles move across the collection surface during operation. In a preferred embodiment, the inlet nozzle is attached to a pivotal arm. Preferably, the arm is attached to an actuator which moves the arm through a pre-set course such that the inlet nozzle sprays an arc of raw material onto the collection surface. For the purposes of this specification, this arc pivot is referred to as a ‘swinging arm’. In one embodiment, a swinging arm is used to spray raw material onto a conveyer belt where the arc tracks the inlet nozzle across the width of the belt. In an alternative embodiment, multiple swinging arms are used on one belt to cover a belt surface and the swinging arms may be arranged in parallel beside each other or in series after each other. Whilst the above description is made with respect to a pivot producing a spray arc, other moving nozzle patterns are envisaged such as straight line back and forth patterns across the belt. An arc pattern should not be seen as limiting.

Preferably, the vacuum pressure in the chamber remains at an approximately steady level of less than or equal to 4.0 mbar. The inventors have found that the vacuum chamber must operate at a pressure below the triple point of the aqueous portion of the raw material to be separated from the solid material. In preferred embodiments, this pressure for water containing raw materials ranges from approximately 0.3 to 4.0 mbar.

In addition to the parameters discussed above, vacuum pressure has been found to be a key variable. For example, if the vacuum pressure is greater than 4 mbar, the raw material tends to fully freeze only after being collected on the conveyer belt. This is not desirable as uneven layer formation results and even small explosions may occur from trapped liquid under an outer solid cap subliming and flashing off breaking open the cap. Opportunities for product deterioration may also result from higher vacuum pressures delaying freezing.

A further factor found important by the inventors has been that it is important that the vacuum pressure remain at an approximately steady level and if changing, that the change occurs at a relatively slow rate. In preferred embodiments, any fluctuations in pressure in the vacuum chamber are less than 0.5 to 1.5 mbar above or below the set vacuum pressure. Fluctuations greater than this, particularly if they occur quickly, may result in uneven layering and potentially sublimation problems such as small explosions noted above.

In a further embodiment, particle size reducing devices may also be incorporated into the design of the dryer. In one preferred embodiment, the vacuum chamber includes a granulator to reduce the product particle size as the dried material leaves the conveyer belt. Preferably, the granulator is a rotor and cutter house configuration.

Preferably, the collection surface or surfaces is or are conveyer belt(s).

Preferably, the belt or belts include at least one inlet nozzle per belt.

In one embodiment, the raw material is injected onto a first upper most conveyer belt and through gravity, the material drops onto at least one further conveyer belt located underneath the first belt until being collected after being dried.

In preferred embodiments, the dryer includes at least two condensing chambers including coils onto which vaporised water or other aqueous substances condense so that in use, one chamber may be used in operation and the other chamber isolated from the vacuum chamber to allow alternate defrosting. It should be appreciated that by having two or more chambers, one chamber may be used in operation and the other chamber isolated from the vacuum chamber to allow alternate defrosting without disrupting processing.

According to a further aspect of the present invention there is provided a dried product produced using the apparatus substantially as described above.

According to a further aspect of the present invention there is provided a dried product produced by the method substantially as described above.

From the above description it should be appreciated that there are provided improved methods and apparatus for drying a raw material having a solid and aqueous portion. Key advantages from the method and apparatus include:
small particle size and formation of a smooth continuous and fine layer (monolayer) on the collection surface resulting in a reduction in energy required compared to traditional batch drying methods;
final product moisture content of approximately 1-2%, comparable to other drying methods;
continuous processing;
reduced labour costs from use of the method and apparatus due to greater automation and removal of steps such as manual loading and unloading of the dryer; and,
reduced cleaning required and the ability to clean in place (CIP).

### BRIEF DESCRIPTION OF DRAWINGS

Further aspects of the present invention will become apparent from the ensuing description which is given by way of example only and with reference to the accompanying drawings in which:

FIG. 1 shows a diagram of a spray freeze dryer according to one aspect of the present invention;

FIG. 2 shows a diagram of one swinging arm configuration; and,

FIG. 3 shows a diagram of one multiple belt configuration in accordance with the present invention.

### BEST MODES FOR CARRYING OUT THE INVENTION

Reference is made to the applicant's co-pending patent applications NZ 529594/529595 and WO 2005/105253 incorporated herein by reference for a detailed description of the method and apparatus. Alternative embodiments described above are now further described in more detail below.

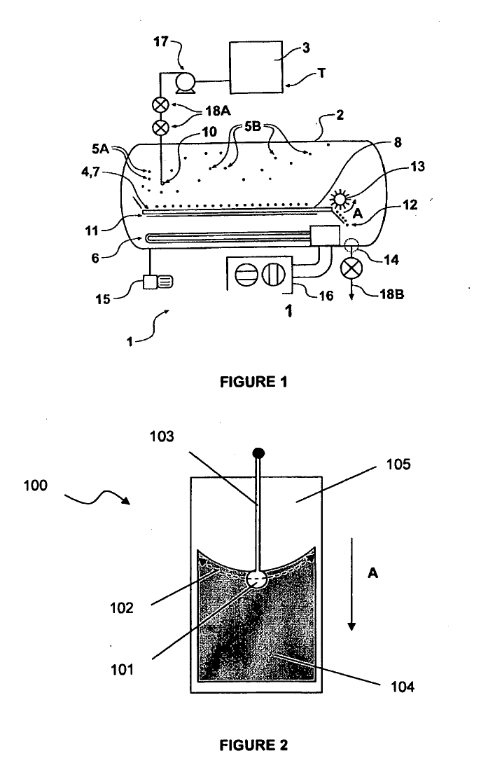

Referring to FIG. 1, an apparatus for drying or concentrating a material having a solid and aqueous portion at ambient conditions is shown. The apparatus includes a spray freeze dryer generally indicated by arrow 1. The dryer 1 includes a vacuum chamber 2 maintained at a pressure below the triple point of the aqueous portion of the raw material using a pump 15.

Raw material 3 is located in a tank T. In this embodiment the raw material contains less than 50% solids dispersed within an aqueous solution.

The raw material is pumped using inlet pump 17 via airlock valves 18A and inlet nozzle 10 into the vacuum chamber 2. The nozzle 10 disperses the raw material 3 as a fine spray and the evaporated portions 5A and 5B vaporises on entry to the chamber 2 and subsequently condenses out on condensing coils 6.

Frozen portion 4 is collected on a conveyer belt 8 as a fine monolayer of frozen material 7. The monolayer 7 is conveyed along the belt 8 and further evaporated portion 5A and 5B sublimes off the frozen portion 4 due to heating panels 11 underneath the belt 8. The dried material 12 is collected 18B via outlet airlock valve 14. A scraper device 13 may be used to remove dried material 12 from the belt 8.

The inventors have found that a critical step in achieving a dried product 12 is the production of a smooth monolayer 7 when the raw material 3 is sprayed into the chamber and collected on the belt 8.

Critical parameters in achieving this monolayer include the rate of conveyance of the belt 8 but also other parameters including the raw material 3 inlet rate; the use of positive pressure from the inlet pump(s) 18A; inlet nozzle 10 size and configuration; and the distance between the inlet nozzle 10 and conveyer belt 8.

In this example the inlet rate is approximately 10 kg/hour of inlet material 3 based on an approximately 9 metre long conveyer belt 8. If the inlet rate is increased above this level, the layer 7 collected on the belt 8 may be too thick to dry sufficiently and may also not fully freeze on forming of a monolayer 7 resulting in small explosions where liquid phase is trapped beneath a solid phase on the monolayer. This liquid phase subsequently boils off and explodes the upper solid layer.

In the example shown in FIG. 1, the raw material 3 is pumped into the vacuum chamber 2 from inlet pumps 18A using a back pressure ranging from approximately 20 to 40 psi. One problem noted by having insufficient back pressure is that discrete snow-like crystals (not shown) are deposited on the conveyer belt surface 7 rather than formation of a monolayer. The crystals also tend to blow around the chamber 2, not staying in one position during drying.

In the example shown in FIG. 1, the inlet nozzle 10 is selected based on atomising sufficient quantities of raw material 3 to allow initial sublimation; transfer of frozen portion to a solid phase; and, to take into account raw material 3 viscosity. One preferred nozzle 10 type is a half cone atomiser which sprays a ring shape pattern.

In the embodiment shown in FIG. 1, the distance between the nozzle 10 outlet and the conveyor belt 8 is approximately 90 mm.

To ensure formation of a smooth, continuous and fine monolayer on the belt 8, the vacuum pressure in the embodiment of FIG. 1 is maintained below 3 mbar. This is done to avoid uneven layer formation results and even small explosions occurring from trapped liquid under an outer solid cap subliming and flashing off breaking open the cap. Fluctuations in pressure are also minimised to assist in avoiding uneven layering and sublimation problems such as small explosions noted above.

The chamber also includes a rotor and cutter house configuration granulator (not shown) inside the vacuum chamber 2, which reduces the particle size of the dried material 12 before it leaves the vacuum chamber 2.

Referring to FIG. 2, a swinging arm embodiment 100 is shown whereby the nozzle 101 moves through an arc 102 defined by a pivoting arm 103 over the collection surface 105. The collection surfaces moves in direction A. The arm 103 is attached to an actuator (not shown), which moves the arm 103 through a pre-set course such that the nozzle 101 sprays an arc 102 of frozen portion which forms a monolayer 104 on the collection surface 105.

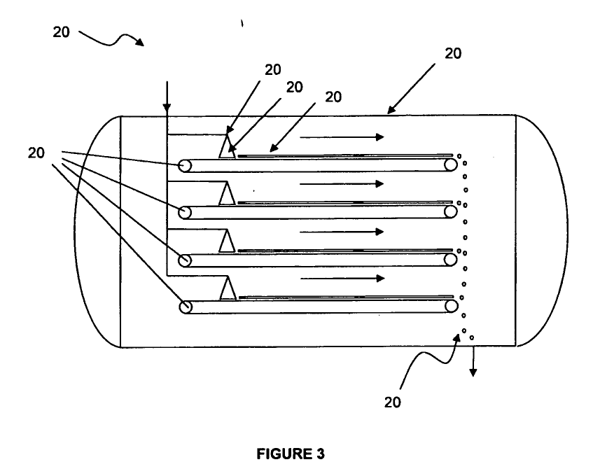

Referring to FIG. 3, a configuration 200 is shown which uses multiple conveyer belts 201. A key advantage of multiple belts 201 within the same vacuum chamber 202 is increased production rates. In the embodiment 200 shown in FIG. 3, the chamber 202 includes four belts 201 stacked vertically, each belt 201 being approximately 1.2 metres wide and 12 metres long. It is envisaged that such an arrangement will be able to produce up to 1 tonne of dry material 203 per day. A monolayer 204 of frozen portion is formed on each belt 201 using multiple inlet nozzles 203 spraying a cone pattern 206 onto the belt 201. In the embodiment shown, one nozzle 205 is used per belt 201. The monolayer 204 moves along the belts 201 and is collected as a dry material 203.

In a further arrangement not shown, the condensing coils are located in one or more adjacent chambers. These chambers may be alternately sealed whereby one chamber may be operated and the other chamber isolated from the vacuum chamber to allow alternate defrosting and cleaning without disrupting processing.

From the above description it should be appreciated that there is provided improved methods and apparatus for drying a solid material containing an aqueous component with improved identification of critical parameters to assist in forming a smooth, continuous and fine layer on the collection surface. The fine layer results in effective drying.

Aspects of the present invention have been described by way of example only and it should be appreciated that modifications and additions may be made thereto without departing from the scope thereof as defined in the appended claims.

What we claim is:

1. An apparatus for drying or concentrating a raw material which at ambient conditions has a solid and aqueous portion including:
(a) a chamber and a chamber pressure reduction device; and,
(b) at least one inlet nozzle through which the raw material is injected into the chamber;
(c) at least one collection surface which collects a frozen portion of the raw material; and,
wherein the pressure reduction device maintains the chamber at a pressure below at least the triple-point pressure of the aqueous portion of the raw material, to cause the injected raw material to separate into a frozen portion and a first evaporated portion; and,
characterised in that the frozen portion is collected on at least one collection surface and accumulated as a layer on the surface or surfaces, the thickness of which is controlled by at least one parameter selected from:
i. the raw material inlet flow rate;
ii. use of positive inlet pressure;
iii. inlet nozzle size and configuration; and/or,
iv. the distance between the inlet nozzle outlet and the collection surface.

2. The apparatus as claimed in claim 1 wherein the thickness of the layer collected on the collection surface is also controlled by the rate of conveyance of the collection surface.

3. The apparatus as claimed in claim 1 or claim 2 wherein the frozen layer on the collection surface is characterised by being smooth, continuous and a fine width.

4. The apparatus as claimed in any one of the above claims wherein the raw material is a solid suspended in or dissolved in the aqueous portion.

5. The apparatus as claimed in any one of the above claims wherein the raw material includes up to 50% solid material.

6. The apparatus as claimed in any one of the above claims wherein the raw material includes less than 30% solid material.

7. The apparatus as claimed in any one of the above claims wherein the raw material inlet flow rate is tailored to the collection surface size at a ratio of 1 kg/hour of raw material per 0.25 to 1.5 metres of collection surface width.

8. The apparatus as claimed in any one of the above claims wherein the positive inlet pressure ranges from approximately 20 to 40 psi.

9. The apparatus as claimed in any one of the above claims wherein the raw material is injected into the vacuum chamber using a nozzle or nozzles that atomise the raw material into small particles.

10. The apparatus as claimed in any one of the above claims wherein the inlet nozzle or nozzles are selected based on injecting sufficient quantities of raw material such that:
(i) initial sublimation of first evaporated portion can occur;
(ii) the frozen portion transfers to a solid; and
(iii) the nozzle size is tailored to the raw material viscosity.

11. The apparatus as claimed in any one of the above claims wherein the nozzle or nozzles spray in a half cone shaped arrangement.

12. The apparatus as claimed in any one of the above claims wherein the distance between the inlet nozzle or nozzles and the collection surface or surfaces varies from between 70 and 120 mm.

13. The apparatus as claimed in any one of the above claims wherein the inlet nozzle or nozzles move across the collection surface during operation.

14. The apparatus as claimed in any one of the above claims wherein the inlet nozzle or nozzles are attached to a pivotal arm or arms which are attached to at least one actuator that moves the arm or arms through a pre-set course such that the inlet nozzle or nozzles spray an arc or arcs of raw material onto the collection surface.

15. The apparatus as claimed in claim 14 wherein the arc of raw material is spread across the width of the collection surface.

16. The apparatus as claimed in any one of the above claims wherein the vacuum pressure in the chamber remains at an approximately steady level of less than or equal to 4.0 mbar.

17. The apparatus as claimed in any one of the above claims wherein any fluctuations in pressure in the vacuum chamber are less than 0.5 to 1.5 mbar above or below the set vacuum pressure.

18. The apparatus as claimed in any one of the above claims wherein the apparatus includes at least one particle size reducing device located within the chamber.

19. The apparatus as claimed in claim 18 wherein the particle size reducing device is a granulator.

20. The apparatus as claimed in claim 19 wherein the granulator is a rotor and cutter house configuration.

21. The apparatus as claimed in any one of the above claims wherein the collection surface or surfaces is or are conveyer belt(s).

22. The apparatus as claimed in claim 21 wherein the chamber includes two or more conveyer belts, stacked in a parallel arrangement within the vacuum chamber.

23. The apparatus as claimed in claim 21 or claim 22 wherein the belt or belts include at least one inlet nozzle per belt.

24. The apparatus as claimed in any one of claims 21 to 23 wherein the raw material is injected onto a first upper most conveyer belt and through gravity, the material drops onto at least one further conveyer belt located underneath the first belt until being collected after being dried.

25. The apparatus as claimed in any one of the above claims wherein the dryer includes at least two condensing chambers including coils onto which vaporised water or other aqueous substances condense so that in use, one chamber may be used in operation and the other chamber isolated from the vacuum chamber to allow alternate defrosting.

26. A dried product produced using the apparatus as claimed in any one of claims 1 to 25.

27. A method of drying or concentrating a raw material which at ambient conditions has a solid and an aqueous portion by the steps of:
(a) holding a chamber at a temperature and pressure below the triple-point of the aqueous portion of the raw material;
(b) injecting the raw material into the chamber from at least one inlet nozzle to generate a frozen portion and a first evaporated portion;
(c) collecting the frozen portion as a layer on at least one collection surface;
(d) conveying the collected frozen portion on the collection surface or surfaces; and,
characterised in that the thickness of the frozen portion on the collection surface is controlled by at least one parameter selected from:
i. the raw material inlet flow rate;
ii. use of positive inlet pressure;
iii. inlet nozzle size and configuration; and/or,
iv. the distance between the inlet nozzle outlet and the collection surface.

28. The method as claimed in claim 27 wherein the thickness of the layer collected on the collection surface is also controlled by the rate of conveyance of the collection surface.

29. The method as claimed in claim 27 or claim 28 wherein the frozen layer on the collection surface is characterised by being smooth, continuous and a fine width.

30. The method as claimed in any one of claims 27 to 29 wherein the raw material is a solid suspended in or dissolved in the aqueous portion.

31. The method as claimed in any one of claims 27 to 30 wherein the raw material includes up to 50% solid material.

32. The method as claimed in any one of claims 27 to 31 wherein the raw material includes less than 30% solid material.

33. The method as claimed in any one of claims 27 to 32 wherein the raw material inlet flow rate is tailored to the collection surface size at a ratio of 1 kg/hour of raw material per 0.25 to 1.5 metres of collection surface width.

34. The method as claimed in any one of claims 27 to 33 wherein the positive inlet pressure ranges from approximately 20 to 40 psi.

35. The method as claimed in any one of claims 27 to 34 wherein the raw material is injected into the vacuum chamber using a nozzle or nozzles that atomise the raw material into small particles.

36. The method as claimed in any one of claims 27 to 35 wherein the inlet nozzle or nozzles are selected based on injecting sufficient quantities of raw material such that:
(i) initial sublimation of first evaporated portion can occur;
(ii) the frozen portion transfers to a solid; and
(iii) the nozzle size is tailored to the raw material viscosity.

37. The method as claimed in any one of claims wherein the nozzle or nozzles spray in a half cone shaped arrangement.

38. The method as claimed in any one of claims 27 to 37 wherein the distance between the inlet nozzle or nozzles and the collection surface or surfaces varies from between 70 and 120 mm.

39. The method as claimed in any one of claims 27 to 38 wherein the inlet nozzle or nozzles move across the collection surface during operation.

40. The method as claimed in any one of claims 27 to 39 wherein the inlet nozzle or nozzles are attached to a pivotal arm or arms which are attached to at least one actuator that moves the arm or arms through a pre-set course such that the inlet nozzle or nozzles spray an arc or arcs of raw material onto the collection surface.

41. The method as claimed in claim 40 wherein the arc of raw material is spread across the width of the collection surface.

42. The method as claimed in any one of claims 27 to 41 wherein the vacuum pressure in the chamber remains at an approximately steady level of less than or equal to 4.0 mbar.

43. The method as claimed in any one of claims 27 to 43 wherein any fluctuations in pressure in the vacuum chamber are less than 0.5 to 1.5 mbar above or below the set vacuum pressure.

44. The method as claimed in any one of claims 27 to 43 wherein the dried material is reduced in particle size within the chamber.

45. The method as claimed in claim 44 wherein the material is reduced in particle size using a granulator.

46. The method as claimed in claim 45 wherein the granulator is a rotor and cutter house configuration.

47. The method as claimed in any one of claims 27 to 46 wherein the collection surface or surfaces is or are conveyer belt(s).

48. The method as claimed in claim 47 wherein the chamber includes two or more conveyer belts, stacked in a parallel arrangement within the vacuum chamber.

49. The method as claimed in claim 47 or claim 48 wherein the belt or belts include at least one inlet nozzle per belt.

50. The method as claimed in any one of claims 47 to 49 wherein the raw material is injected onto a first upper most conveyer belt and through gravity, the material drops onto at least one further conveyer belt located underneath the first belt until being collected after being dried.

51. The method as claimed in any one of claims 27 to 50 wherein the dryer includes at least two condensing chambers including coils onto which vaporised water or other aqueous substances condense so that in use, one chamber may be used in operation and the other chamber isolated from the vacuum chamber to allow alternate defrosting.

52. A dried product produced by the method as claimed in any one of claims 27 to 51.
